(19) United States
(12) Patent Application Publication
(10) Pub. No.: US 2020/0388264 A1
(43) Pub. Date: Dec. 10, 2020

(54) YANG BAMBOO AMPLIFIER AND HOLDER

(71) Applicants: John Peng Chang Yang, Lakeland, FL (US); Sarah Shu Ming Yang, Lakeland, FL (US)

(72) Inventors: John Peng Chang Yang, Lakeland, FL (US); Sarah Shu Ming Yang, Lakeland, FL (US)

(21) Appl. No.: 16/027,536

(22) Filed: Jul. 5, 2018

(51) Int. Cl. G10K 11/08

(52) U.S. Cl. CPC G10K 11/08

(57) ABSTRACT

A bamboo amplifier and holder is described. In some examples, the bamboo amplifier and holder can include a bamboo tube, a device slot, one or more charging slots, a rechargeable battery and a mechanism to support the bamboo tube. The device slot is configured to receive a device and the bamboo tube is configured to amplify the sound emitted and/or generated by the device. The charging slots are each configured to accommodate a charging port. The device can be charged when connected to the rechargeable battery. Also, the rechargeable battery can be charged when connected to an external power source. These connections can be via one or more charging ports.

### FIELD

Some implementations relate generally to an apparatus for holding a media device and/or a communications device (e.g., a phone) as well as amplifying sound generated/emitted by such a device, i.e., a holder and amplifier apparatus, and specifically, a bamboo amplifier and holder apparatus.

### BACKGROUND

Devices for amplifying sound typically require an external power source. A drawback of such amplifiers is dependence on an external power source, which may not always be available. Also, such amplifiers typically do not provide an option to charge the device whose sound the amplifiers sought to amplify.

The conventional techniques for amplifying sound are therefore not convenient in certain situations. Examples of such situations include absence of an external source to power the amplifier or absence of an external source to charge the device whose sound is being amplified.

It may be desirable to provide a bamboo amplifier and holder capable of amplifying the sound of another device without electricity from a power source while at the same time able to charge the device in varying situations. Some implementations were conceived in light of the above-mentioned needs, limitations, or problems, among other things.

### SUMMARY

Some implementations include a bamboo amplifier and holder. A bamboo amplifier and holder can include a bamboo tube and a mechanism to support the bamboo tube. The bamboo amplifier and holder can also include a device slot to receive a device, a rechargeable battery in the bamboo tube and charging slots, where each charging slot accommodates a charging port. The bamboo tube uses one or more apertures within the bamboo amplifier and holder to amplify sound emitted by the device. The device can be a communications device, a mobile phone, or a media player while the charging port can be a USB port. The mechanism to support the bamboo tube and the bamboo tube can form a single integrated unit without one or more joints, interfaces, connections, or attachments.

The charging port can be connected to the rechargeable battery. In some implementations, connecting the charging port to a power source enables charging of the rechargeable battery with electricity from the power source. In some other implementations, connecting the charging port to the device enables charging of the device with electricity from the rechargeable battery.

A method for amplifying sound of a device can include inserting the device into a device slot of a bamboo tube and configuring the device to emit the sound, wherein the bamboo tube is configured to amplify the sound emitted by the device. In some implementations, the bamboo tube comprises one or more apertures to enable amplification of sound emitted by the device.

In some implementations, the method for amplifying sound of a device can include a bamboo tube comprising one or more charging slots configured to accommodate a charging port. Also, the charging port can be connected to a rechargeable battery. In some implementations, connecting the charging port to a power source enables charging of the rechargeable battery with electricity from the power source. In some other implementations, connecting the charging port to the device enables charging of the device with electricity from the rechargeable battery. The device can be one or more of a mobile phone, a media player and a communications device.

A method for charging a device can include inserting the device into a device slot of a bamboo tube and enabling a rechargeable battery in the bamboo tube to charge the device, wherein the device is connected to the rechargeable battery via one of a wired and a wireless connection. In some implementations, the bamboo tube can include one or more charging slots configured to accommodate a charging port. Also, the charging port can be connected to the rechargeable battery.

In some implementations, connecting the charging port to a power source enables the charging of the rechargeable battery with electricity from the power source. In some other implementations, connecting the charging port to the device enables charging of the device with electricity from the rechargeable battery. The device can be one or more of a mobile phone, a media player and a communications device. The charging port can, for instance, be a USB port.

### BRIEF DESCRIPTION OF THE DRAWINGS

FIG. 1 is a diagram showing a left side elevation view of an example bamboo amplifier and holder in accordance with some implementations.

FIG. 2 is a diagram showing a right side elevation view of an example bamboo amplifier and holder in accordance with some implementations.

FIG. 3 is a diagram showing a front elevation view of an example bamboo amplifier and holder in accordance with some implementations.

FIG. 4 is a diagram showing a top elevation view of an example bamboo amplifier and holder in accordance with some implementations.

FIG. 5 is a diagram showing a left, top perspective view of an example bamboo amplifier and holder in accordance with some implementations.

### DETAILED DESCRIPTION

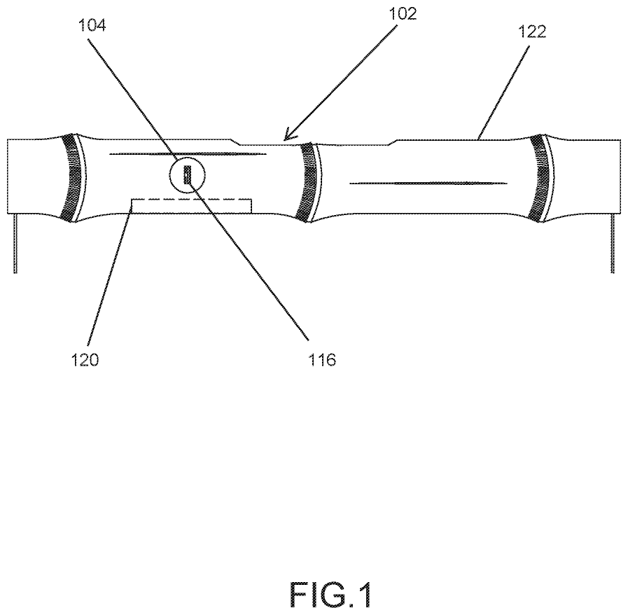

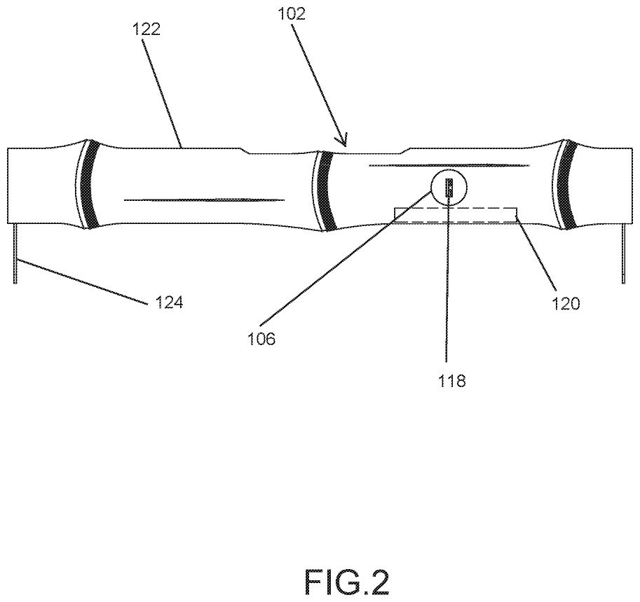

FIGS. 1-5 show drawings of an example bamboo amplifier and holder (e.g., 100). As shown in FIG. 1, an example bamboo amplifier and holder 100 includes a device slot 102, a first charging slot 104, a first charging port 116, a rechargeable battery 120 and a bamboo tube 122. In FIG. 2, the example bamboo amplifier and holder 100 includes the device slot 102, a second charging slot 106, a second charging port 118, the rechargeable battery 120, the bamboo tube 122 and a mechanism (e.g., a stand) 124 to support the bamboo tube on a planar surface.

In some implementations, the rechargeable battery is connected to a charging port. In such cases, the rechargeable battery can be charged from an external power source by also connecting the charging port to an external power source. Also, the device can be charged by connecting the charging port to the device. In some other implementations, the connection between the rechargeable battery and the device and/or the rechargeable battery and the power source can be via wireless technology or induction among other implementations. The connectivity mechanisms described herein are for illustration purposes only, not intended to be limiting, and can take other shapes and forms depending on a contemplated implementation.

In some implementations, the device can be charged without a rechargeable battery by connecting the device to the first charging port and the second charging port to the external power source so that electricity flows from the power source to the device via the charging ports. The connection between the device and the charging port can be via wireless technology or induction technologies, or alternatively via a wired connection, among other implementations.

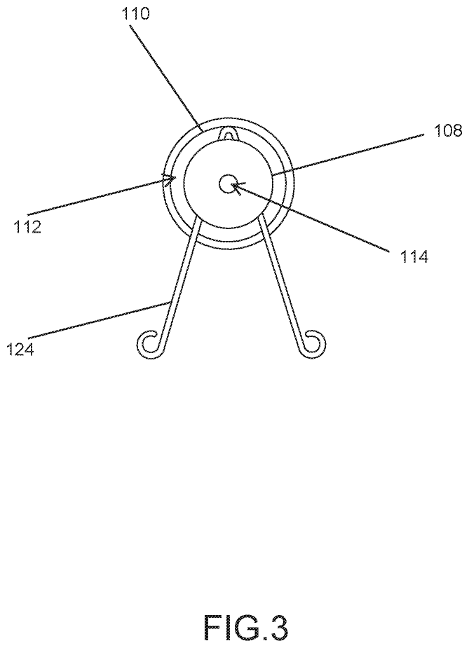

In FIG. 3, an example bamboo amplifier and holder includes an end cap/cover 108, inner surface 110 of the bamboo tube, a first aperture 112 of the bamboo tube, a second aperture 114 of the end cap/cover and a mechanism (e.g., a pair of stands) 124 to support the bamboo tube. The mechanism can be made of plastic, metal, wood, stone, composite, synthetic, thermoplastic, rubber, textile, plant fiber, natural and man-made materials. Also, it will be appreciated that the mechanism described herein is for illustration purposes only and is not intended to be limiting. Other mechanisms and materials could be used depending on a contemplated implementation.

In some implementations, sound of a device inserted into the device slot is amplified with the help of the first aperture and the second aperture as well as the configuration of the bamboo tube, which is hollow. Also, the material of the bamboo tube further enables the amplification. The shapes, forms and structures of the first and second apertures, the bamboo tube and the end cap/cover described herein are for illustration purposes only, not intended to be limiting, and can take other shapes, forms and structures depending on a contemplated implementation. Similarly, the shape, form and structure of the mechanism described herein to support the bamboo tube is for illustration purposes only, not intended to be limiting, and can take other shapes, forms and structures depending on a contemplated implementation.

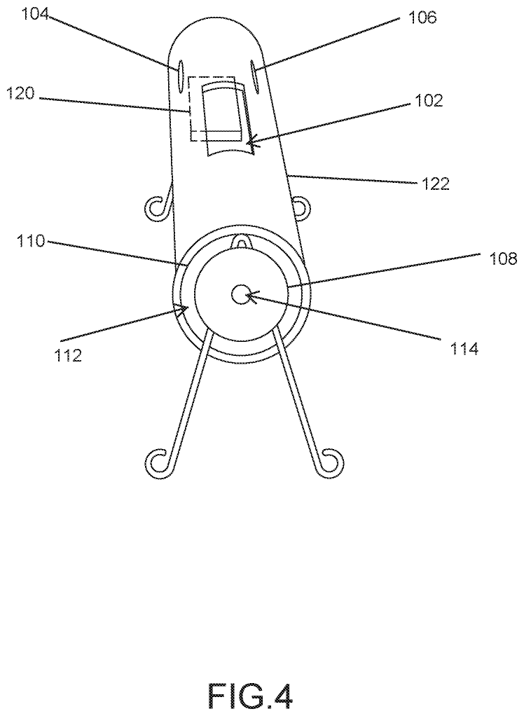

In FIG. 4, an example bamboo amplifier and holder includes a device slot 102, a first charging slot 104, a second charging slot 106, an end cap/cover 108, inner surface 110 of a bamboo tube 122, a first aperture 112 of the bamboo tube, a second aperture 114 of the end cap/cover, a rechargeable battery 120, and a support mechanism (e.g., a pair of stands) 124.

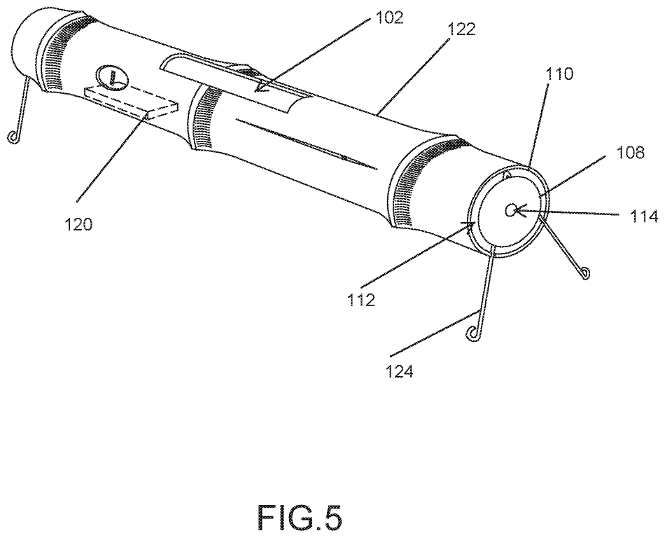

FIG. 5 is a left, top perspective view of the example bamboo amplifier and holder shown in FIG. 4 and includes the device slot 102, the end cap/cover 108, the inner surface 110 of the bamboo tube 122, the first aperture 112 of the bamboo tube, the second aperture 114 of the end cap/cover, the rechargeable battery 120, and the support mechanism (e.g., a pair of stands) 124.

It is therefore apparent that there is provided, in accordance with the various example implementations disclosed herein, a bamboo amplifier and holder apparatus.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

1. A bamboo amplifier and holder comprising:
a bamboo tube;
a mechanism for supporting the bamboo tube;
a rechargeable battery inserted within the bamboo tube;
a device slot in the bamboo tube configured to receive a device; and
one or more charging slots in the bamboo tube configured to accommodate a charging port.

2. The bamboo amplifier and holder of claim 1, wherein the bamboo tube amplifies sound emitted by the device via one or more apertures within the bamboo amplifier and holder.

3. The bamboo amplifier and holder of claim 1, wherein the charging port is connected to the rechargeable battery.

4. The bamboo amplifier and holder of claim 3, wherein connecting the charging port to a power source enables charging of the rechargeable battery with electricity from the power source.

5. The bamboo amplifier and holder of claim 3, wherein connecting the charging port to the device enables charging of the device with electricity from the rechargeable battery.

6. The bamboo amplifier and holder of claim 1, wherein the charging port is a USB port.

7. The bamboo amplifier and holder of claim 1, wherein the device is at least one of a mobile phone, a media player and a communications device.

8. The bamboo amplifier and holder of claim 1, wherein the mechanism and the bamboo tube form a single integrated unit without one or more joints, interfaces, connections, or attachments.

9. A method for amplifying sound of a device, the method comprising:
inserting the device into a device slot of a bamboo tube; and
configuring the device to emit the sound,
wherein the bamboo tube is configured to amplify the sound emitted by the device.

10. The method of claim 9, wherein the bamboo tube comprises one or more apertures to enable amplification of the sound emitted by the device.

11. The method of claim 9, wherein the bamboo tube comprises one or more charging slots configured to accommodate a charging port.

12. The method of claim 11, wherein the charging port is connected to a rechargeable battery.

13. The method of claim 12, wherein connecting the charging port to a power source enables charging of the rechargeable battery with electricity from the power source.

14. The method of claim 12, wherein connecting the charging port to the device enables charging of the device with electricity from the rechargeable battery.

15. The method of claim 9, wherein the device is at least one of a mobile phone, a media player and a communications device.

16. A method for charging a device, the method comprising:
inserting the device into a device slot of a bamboo tube; and
enabling a rechargeable battery in the bamboo tube to charge the device, wherein the device is connected to the rechargeable battery via at least one of a wired and a wireless connection.

17. The method of claim 16, wherein the bamboo tube comprises one or more charging slots configured to accommodate a charging port.

18. The method of claim 17, wherein the charging port is connected to the rechargeable battery.

19. The method of claim 18, wherein connecting the charging port to a power source enables charging of the rechargeable battery with electricity from the power source.

20. The method of claim 18, wherein connecting the charging port to the device enables charging of the device with electricity from the rechargeable battery.

21-23. (canceled)
